(19) United States
(12) Patent Application Publication
(10) Pub. No.: US 2023/0367238 A1
(43) Pub. Date: Nov. 16, 2023

(54) DEVICE MANAGEMENT SYSTEM AND COOPERATION METHOD

(71) Applicant: CANON KABUSHIKI KAISHA, Tokyo (JP)

(72) Inventor: Yuzuru Okubo, Kanagawa (JP)

(21) Appl. No.: 18/141,531

(22) Filed: May 1, 2023

(30) Foreign Application Priority Data
May 10, 2022 (JP) 2022-077694

(51) Int. Cl. G03G 15/08

(52) U.S. Cl. CPC G03G 15/0856

(57) ABSTRACT

A device management system cooperates with a delivery system configured to deliver a recording material based on a comparison result between a remaining amount of the recording material to be used in a printing apparatus and a delivery threshold. The system includes an acquisition unit configured to acquire a remaining amount of a recording material in the printing apparatus, a conversion unit configured to convert the remaining amount of the recording material in the printing apparatus into a virtual remaining amount, and a transmission unit configured to transmit the virtual remaining amount to the delivery system as the remaining amount of the recording material in the printing apparatus.

### BACKGROUND OF THE INVENTION

### Field of the Invention

The present invention relates to a device management system and a cooperation method.

### Description of the Related Art

An automatic delivery function has been proposed for delivering replenishment of a consumable to a user before an image forming apparatus runs out of the consumable and cannot form an image. With regard to such an automatic delivery function, Japanese Patent No. 5,158,145 proposes a technique for switching between delivery settings based on the consumption history of individual device. More specifically, a period required for consumption is calculated based on the use history until running out of a consumable, and a setting for automatic delivery is performed by comparing the calculated period with a period required for delivery. A delivery threshold used for delivering replenishment of a consumable may vary depending on the type of consumable. For example, a delivery threshold for a large-volume consumable (e.g., ratio relative to initial remaining amount) can be lower than that for a small-volume consumable. However, a common delivery threshold may be set for a plurality of types of consumables having different delivery thresholds, depending on the delivery system that delivers the consumables. In such a case, a delivery threshold which has been set for the individual consumable may not match the commonly set delivery threshold, which can lead to inability to deliver the replenishment of the consumable at an appropriate timing.

### SUMMARY OF THE INVENTION

An aspect of the present disclosure provides a technique that facilitates delivery of consumables at an appropriate timing.

According to an embodiment, a device management system cooperating with a delivery system configured to deliver a recording material based on a comparison result between a remaining amount of the recording material to be used in a printing apparatus and a delivery threshold, the device management system comprising: an acquisition unit configured to acquire a remaining amount of a recording material in the printing apparatus; a conversion unit configured to convert the remaining amount of the recording material in the printing apparatus into a virtual remaining amount; and a transmission unit configured to transmit the virtual remaining amount to the delivery system as the remaining amount of the recording material in the printing apparatus, is provided.

Further features of the present invention will become apparent from the following description of exemplary embodiments (with reference to the attached drawings).

### BRIEF DESCRIPTION OF THE DRAWINGS

FIG. 1 is an explanatory schematic diagram of a configuration example of an image forming apparatus according to some embodiments.

FIG. 2 is an explanatory block diagram of a configuration example of an image forming apparatus according to some embodiments.

FIG. 3 is an explanatory block diagram of a configuration example of an information processing apparatus according to some embodiments.

FIG. 4 is an explanatory block diagram of a configuration example of an automatic delivery system according to some embodiments.

FIG. 5 is an explanatory flowchart of an exemplary method for setting a common delivery threshold according to some embodiments.

FIG. 6 is an explanatory flowchart of an exemplary cooperation method according to some embodiments.

FIGS. 7A and 7B are explanatory diagrams of an exemplary method for deciding a conversion function according to some embodiments.

FIG. 8 is an explanatory flowchart of a variation example of the cooperation method according to some embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

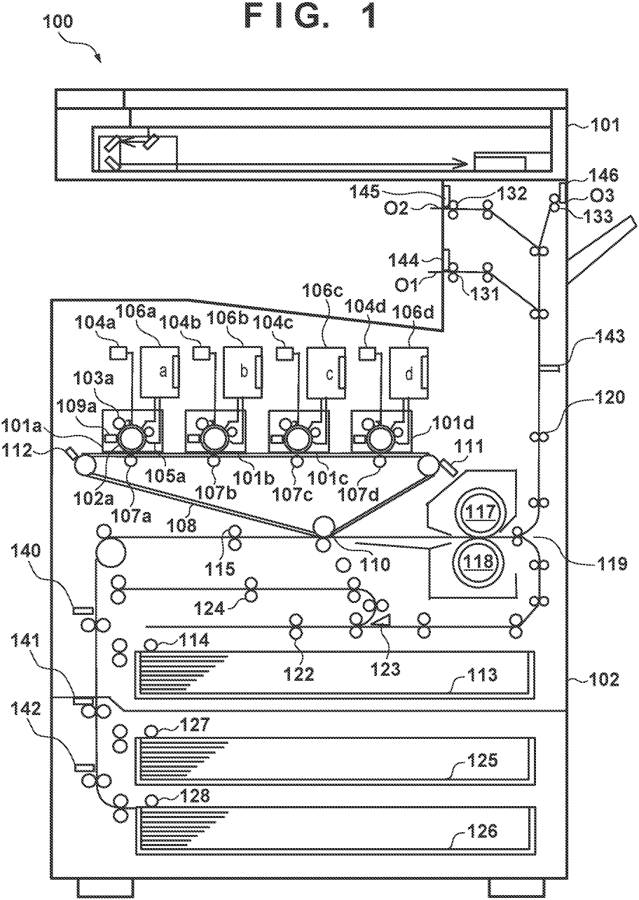

Referring to FIG. 1, a configuration example of an image forming apparatus 100 according to some embodiments will be described. The image forming apparatus 100 may also be referred to as a printing apparatus. The image forming apparatus 100 includes a document reading unit 101 and an image forming unit 102. The image forming apparatus 100 may include an operation unit such as a liquid crystal display with a touch panel installed thereon. The operation unit may present information to the user and accept input operation such as specification of the number of sheets to be printed, by providing a graphical user interface (GUI) or the like.

The document reading unit 101 reads an original document stacked on an original glass plate and outputs image data representing the original document. The image forming unit 102 forms an image on a printing material (such as paper sheet) in accordance with image data output from the document reading unit 101 or image data transmitted from an external apparatus connected via a network.

The image forming unit 102 includes a plurality of process units 101a to 101d in one-to-one correspondence with a plurality of colors (e.g., black, yellow, cyan, and magenta) available in the image forming apparatus 100. The image forming unit 102 further includes a plurality of laser scanner units 104a to 104d, a plurality of cartridge units 106a to 106d, and a plurality of primary transfer rollers 107a to 107d. The aforementioned components are respectively in one-to-one correspondence with the plurality of process units 101a to 101d. Next, the process unit 101a will be described. The description of the process unit 101a also applies to the process units 101b to 101d.

The process unit 101a includes a photosensitive drum 102a, a charge roller 103a, a developing device 105a, and a complementary charge brush 109a. The photosensitive drum 102a is accommodated in the central portion of the process unit 101a. The photosensitive drum 102a is rotationally driven by an unillustrated drum motor. The charge roller 103a applies a high voltage to the photosensitive drum 102a to uniformly charge the surface of the photosensitive drum 102a. The laser scanner unit 104a sweeps a laser beam modulated output from a laser diode in the longitudinal direction of the photosensitive drum 102a by using a polygon mirror rotator. The laser scanner unit 104a performs laser exposure in accordance with input image information to form an electrostatic latent image on the uniformly charged photosensitive drum 102a.

The developing device 105a uses two-component developer containing toner and carrier to form, on the photosensitive drum 102a, a visible toner image corresponding to the electrostatic latent image. The cartridge unit 106a includes a cartridge filled with the toner and a toner conveying mechanism and supplies the toner to the developing device 105a. With the toner being a consumable material, the cartridge is configured to be replaceable from the cartridge unit 106a in an attaching and detaching manner.

The primary transfer roller 107a primarily transfers the toner image from the photosensitive drum 102a to an intermediate transfer member 108 being an endless belt-like member. The complementary charge brush 109a charges the residual toner left over after the transfer by the primary transfer roller 107a to be uniformly charged.

A secondary transfer roller 110 secondarily transfers, to a printing material (paper sheet or the like, and will be referred to as “sheet” in the following), the toner image which has been primarily transferred to the intermediate transfer member 108 as described above. An intermediate transfer member cleaner 111 collects residual toner left over after the transfer by the secondary transfer roller 110 as well as toner used to form a toner image for adjustment that is not intended to be transferred to the sheet and stores the collected toner in an unillustrated residual toner storage container. A pattern density detection sensor 112 detects a change in shading of patterns formed on the intermediate transfer member 108.

A sheet feed cassette 113, an additional sheet feed cassette 125, and an additional sheet feed cassette 126 respectively accommodate sheets. A sheet feed roller 114 feeds a sheet from the sheet feed cassette 113. A sheet feed roller 127 feeds a sheet from the additional sheet feed cassette 125. A sheet feed roller 128 feeds a sheet from the additional sheet feed cassette 126.

A registration roller 115 corrects skew of a sheet that is fed and sends the sheet to the secondary transfer roller 110. The secondary transfer roller 110 transfers the toner image to the sheet. A fixing roller 117 and a pressure roller 118 thermally fix the toner image transferred to the sheet. A sheet-discharge flapper 119 sends a sheet having a toner image fixed thereon to sheet-discharge ports O1, O2 and O3, or a double-sided inversion drive 122 via a sheet-discharge path 120. Sheet detection sensors 140 to 146 provided along the sheet conveyance path are used for sheet conveyance control and sheet-jam detection.

The sheet sent to the double-sided inversion drive 122 is sent to a double-sided sheet refeeding drive 124 by the reverse rotation of the double-sided inversion drive 122 and pivotally move of the double-sided inversion flapper 123, and after the image formation on the second side of the sheet is performed again, the sheet is subsequently sent to the sheet-discharge ports O1, O2 and O3. Sheet-discharge rollers 131 to 133 are provided in the vicinity of the sheet-discharge ports O1, O2 and O3, respectively. The sheet-discharge rollers 131 to 133 discharge the sheets sent to the sheet-discharge ports O1, O2 and O3, respectively, to the outside of the apparatus.

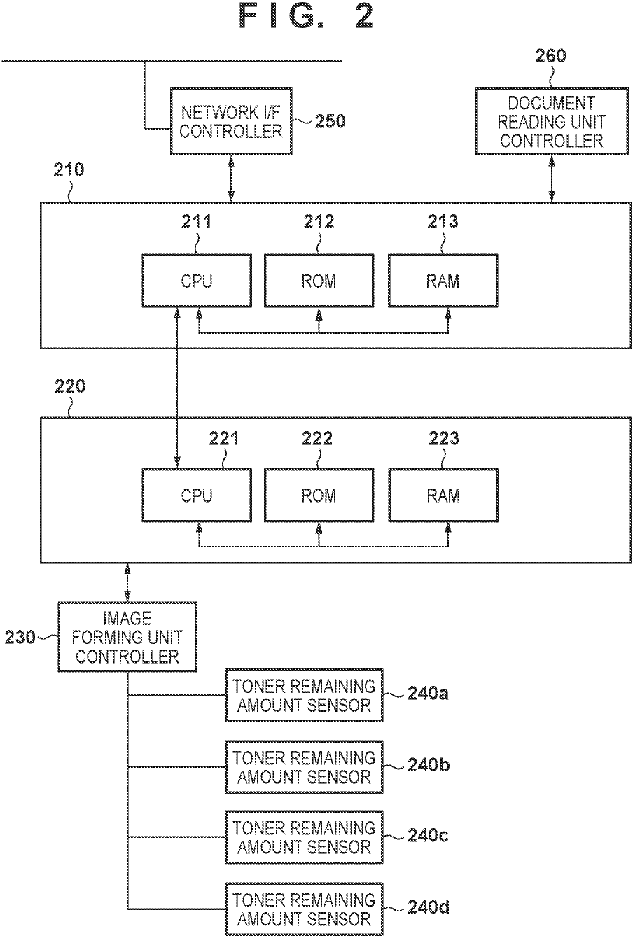

Referring to FIG. 2, a configuration example of a control circuit of the image forming apparatus 100 will be described. The control circuit of the image forming apparatus 100 includes a job management unit 210, an image forming circuit unit 220, an image forming unit controller 230, a network interface (I/F) controller 250, and a document reading unit controller 260.

The job management unit 210 includes a Central Processing Unit (CPU) 211, a Read Only Memory (ROM) 212, and a Random Access Memory (RAM) 213. The CPU 211 controls the network I/F controller 250 and the document reading unit controller 260. The ROM 212 stores programs and data for operating the CPU 211. The RAM 213 including a backup storage function is used to temporarily store results of calculation performed by the CPU 211.

The image forming circuit unit 220 includes a CPU 221, a ROM 222, and a RAM 223. The CPU 221 exchanges, with the CPU 211, jobs, image data, information relating to consumables such as toner, or the like to control the image forming unit controller 230. The ROM 222 stores programs and data for operating the CPU 221. The RAM 223 including a backup storage function is used to temporarily store results of calculation performed by the CPU 221.

The network I/F controller 250 is connected to an external network and controls communication, with an external apparatus, of job data and information related to management of consumables such as toner or the like. The document reading unit controller 260 controls the document reading unit 101 to read the original document and transfers the read image data to the CPU 211.

The image forming unit controller 230 controls units related to image formation, in accordance with control signals provided from the CPU 221. For example, the image forming unit controller 230 drives an unillustrated drum motor. The units related to image formation may include, for example, the process units 101a to 101d, the cartridge units 106a to 106d, or the like.

Toner remaining amount sensors 240a to 240d each provided along a supply path of toner supplied from the corresponding one of the cartridge units 106a to 106d detect the toner supplied from the corresponding one of the cartridge units 106a to 106d. As such, the toner remaining amount sensors 240a to 240d detect the toner supplied from the cartridge units 106a to 106d, respectively. Accordingly, the image forming unit controller 230 can determine whether toner remains in each of the cartridge units 106a to 106d.

In addition, the image forming unit controller 230 controls the units related to sheet conveyance. For example, the image forming unit controller 230 drives the sheet feed rollers 114, 127 and 128 by using an unillustrated sheet feed conveyance motor. In addition, the image forming unit controller 230 drives the fixing roller 117 and the pressure roller 118 by using a fixing motor and further controls the units related to fixing operations including heating of the fixing roller 117 and the pressure roller 118 by using a fixing heater. The aforementioned control performed by the image forming unit controller 230 is an example to which the present embodiment is not limited.

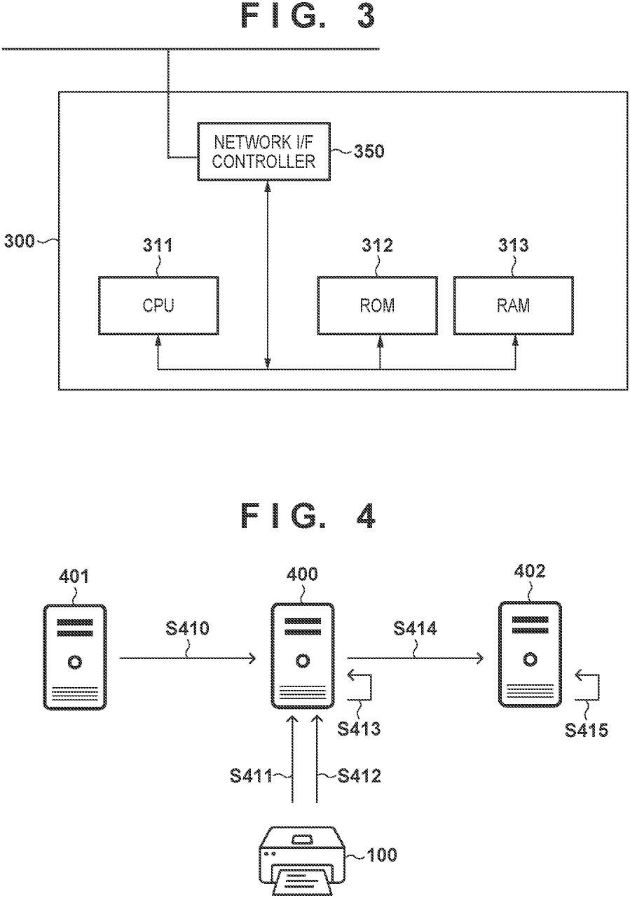

Referring to FIG. 3, an information processing apparatus 300 included in the system for achieving the automatic delivery function will be described. The information processing apparatus 300 includes a CPU 311, a ROM 312, and a RAM 313. The CPU 311 controls the overall operation of the information processing apparatus 300 to execute one or more functions of the information processing apparatus 300. The ROM 312 stores programs and data for operating the CPU 311. The RAM 313 including a backup storage function is used to temporarily store results of calculation performed by the CPU 311. A network I/F controller 350 is connected to an external network and controls communication, with an external apparatus, of job data and information related to management of consumables such as toner.

Referring to FIG. 4, a configuration example and an overall operation flow of an automatic delivery system for a consumable for a device will be described. In the following, the device will be described taking the image forming apparatus 100 as an example thereof. The device is not limited to the image forming apparatus 100 and may be another device such as a robot cleaner. In addition, the following description takes a recording material loaded in a cartridge mounted on the image forming apparatus 100 as an example of the consumable. Consumables are not limited to the recording material and may be other consumables such as photosensitive members or waste toner boxes. Furthermore, the following description takes toner as an example of a recording material. The recording material is not limited to toner and may be ink or the like, for example.

The automatic delivery system includes, for example, the image forming apparatus 100, a device management system 400, a portal system 401, and a delivery system 402. Each of the device management system 400, the portal system 401, and the delivery system 402 may be implemented by a single information processing apparatus 300 or may be implemented by a plurality of the information processing apparatuses 300. In addition, the device management system 400, the portal system 401, and the delivery system 402 may be constructed in an on-premises environment or may be constructed in a cloud environment. The device management system 400 can communicate with each of the image forming apparatus 100, the portal system 401, and the delivery system 402 via a network. The network may be a wide area network such as the Internet or may be a local area network.

The device management system 400 manages the image forming apparatus 100. Although only a single image forming apparatus 100 is illustrated in FIG. 4, the device management system 400 can manage a plurality of the image forming apparatuses 100. For example, the device management system 400 receives toner information transmitted by the job management unit 210 of the image forming apparatus 100 and manages the toner information. In addition, the device management system 400 achieves the automatic toner delivery by cooperating with the delivery system 402. For example, the device management system 400 transmits, to the delivery system 402, the remaining amount of toner in the cartridge being used in the image forming apparatus 100.

The image forming apparatus 100 may be able to mount a plurality of types of cartridges. For example, the image forming apparatus 100 may be able to mount a standard cartridge and a large-capacity cartridge. The initial remaining amount of toner in the large-capacity cartridge is greater than the initial remaining amount of toner in the standard cartridge. The initial remaining amount is the amount of toner contained in an unused cartridge. The image forming apparatus 100 may be able to further mount a starter cartridge. The initial remaining amount of toner in the starter cartridge is smaller than the initial remaining amount of toner in the standard cartridge. The plurality of types of cartridges may include cartridges for printing different colors.

The device management system 400 manages a delivery threshold for each of the plurality of types of cartridges. A delivery threshold is the remaining amount of toner as a reference for delivering replenishment toner. When the remaining amount of toner falls below the delivery threshold, replenishment toner is delivered to a user of the image forming apparatus 100 (hereinafter, simply referred to as user). The delivery threshold of each of the plurality of types of cartridges may be set by a user or may be set by an administrator of the device management system 400.

The delivery threshold can vary depending on the type of cartridge. For example, the delivery threshold for a large-capacity cartridge is lower than the delivery threshold for a standard cartridge. For example, the delivery threshold for a standard cartridge may be set to 30% of the initial remaining amount. The delivery threshold for the large-capacity cartridge may be set to 10% of the initial remaining amount. As has been described above, delivery thresholds are individually set for cartridges usable in the image forming apparatus 100, and the delivery thresholds individually set for a plurality of types of cartridges are different from each other. In the following, the delivery thresholds individually set for cartridges usable in the image forming apparatus 100 will be referred to as individual delivery thresholds.

The portal system 401 provides a user with a portal site for accessing the device management system 400. For example, a user accesses a portal site by using a web browser or the like. By using the portal site, the user registers, in the device management system 400, the image forming apparatus 100 that uses the toner desired to be automatically delivered. Based on the input from the user, the portal system 401 registers, in the device management system 400, the user account for the delivery system 402 and the image forming apparatus 100 owned by the user in association with each other. Furthermore, the portal system 401 may also be used to set a delivery threshold of a cartridge that can be mounted on the image forming apparatus 100.

The delivery system 402 delivers toner based on a comparison result between the remaining amount of toner to be used in the image forming apparatus 100 and the delivery threshold. For example, the delivery system 402 delivers a replenishment cartridge to the user, in response to the falling of the remaining amount of toner transmitted from the device management system 400 below the delivery threshold.

It is assumed in the delivery system 402 according to some embodiments that a single delivery threshold can be set for a plurality of types of cartridges that can be used in a single image forming apparatus 100. The single delivery threshold is commonly set for a plurality of types of cartridges that can be used in a single image forming apparatus 100. The delivery threshold is thus referred to as a common delivery threshold. As has been described above, a plurality of types of cartridges having different individual delivery thresholds can be mounted, depending on the image forming apparatus 100. The delivery system 402 according to such an embodiment performs the delivery by using an identical common delivery threshold for a plurality of types of cartridges having different individual delivery thresholds. Thus, transmitting the remaining amount of toner directly to the delivery system 402 by the device management system 400 may hinder delivery of toner at an appropriate timing.

For example, assuming that the individual delivery threshold for a standard cartridge is 30%, the individual delivery threshold for a large-capacity cartridge is 10%, and the common delivery threshold for the standard cartridge and the large-capacity cartridge is 20%. When a standard cartridge is mounted on the image forming apparatus 100, the delivery system 402 delivers toner by using the common delivery threshold (20%) lower than the individual delivery threshold (30%) for the standard cartridge, and thus toner is delivered later than expected by the user. When a large-capacity cartridge is mounted on the image forming apparatus 100, the delivery system 402 delivers toner by using the common delivery threshold (20%) higher than the individual delivery threshold (10%) for the large-capacity cartridge, and thus toner is delivered earlier than expected by the user. In some embodiments, therefore, the device management system 400 converts the remaining amount of toner into a virtual remaining amount described below and subsequently transmits the virtual remaining amount, instead of transmitting the remaining amount of toner directly to the delivery system 402.

It is assumed in the aforementioned embodiment that a single common delivery threshold can be set to cartridges that can be mounted on a single image forming apparatus 100. Alternatively, a single common delivery threshold may be settable to cartridges that can be mounted on a single slot of a single image forming apparatus 100. With the term “slot” referring to a place where a cartridge is attached to the image forming apparatus 100, a common delivery threshold is used for cartridges having different initial remaining amounts because the same slot is used when, for example, such cartridges are attached to the same place.

Next, an overall operation flow of the automatic delivery system of FIG. 4 will be described. The following operation may be implemented by executing, by a processor (e.g., CPU 311) of each system included in the automatic delivery system, a program read into the memory (e.g., RAM 313). The operation illustrated in FIG. 4 may be initiated in response to the user accessing the portal system 401.

At S410, in response to accepting an instruction from the user to register the image forming apparatus 100, the portal system 401 transmits, to the device management system 400, device information related to the image forming apparatus 100 and user information related to the user. For example, the device information to be transmitted may be identification information of the image forming apparatus 100, such as a serial number of the image forming apparatus 100. The user information to be transmitted may be identification information of the user, such as a mail address or a unique user ID.

At S411, the image forming apparatus 100 performs an activation process on the device management system 400. A successful activation process suggests that the image forming apparatus 100 has been normally connected to the device management system 400. After a successful completion of the activation process, the image forming apparatus 100 can transmit the toner information to the device management system 400.

At S412, the image forming apparatus 100 transmits identification information and toner information of the image forming apparatus 100 to the device management system 400. The toner information may include a current remaining amount of toner, color of toner, and type of toner cartridge (e.g., initial remaining amount or maximum capacity). The toner information may further include a status of toner. The status of toner may include a status (e.g., toner clogging in the cartridge) for determining whether the cartridge being used is to be replaced.

When a single image forming apparatus 100 is using a plurality of types of toner, the image forming apparatus 100 may transmit toner information for each of the plurality of types of toner. The image forming apparatus 100 may repeatedly transmit the toner information. For example, the image forming apparatus 100 may transmit the toner information at a predetermined period (e.g., once a day) or may transmit the toner information in response to occurrence of a specific event (e.g., each time the number of times printing exceeds a threshold).

At S413, the device management system 400 converts the remaining amount of toner included in the received toner information into a virtual remaining amount. Details of the processing at S413 will be described below. At S414, the device management system 400 transmits the virtual remaining amount acquired at S413 to the delivery system 402 as the remaining amount of toner of the image forming apparatus 100.

At S415, the delivery system 402 determines whether the remaining amount of toner received at S414 has fallen below the common delivery threshold for cartridges that can be mounted on the image forming apparatus 100. When the remaining amount of toner has fallen below the common delivery threshold, the delivery system 402 starts processing of ordering and delivering toner. Detection of the toner consumption rate may be performed by using, for example, a known consumption detection method based on counter management that calculates the toner consumption amount from accumulated time of rotating the cartridge rotation motor.

The processing operations from S413 to S415 may be performed each time the device management system 400 receives toner information from the image forming apparatus 100. In a case where the device management system 400 manages a plurality of image forming apparatuses 100, the processing operations from S413 to S415 may be performed each time the device management system 400 receives toner information from any of the plurality of image forming apparatuses 100.

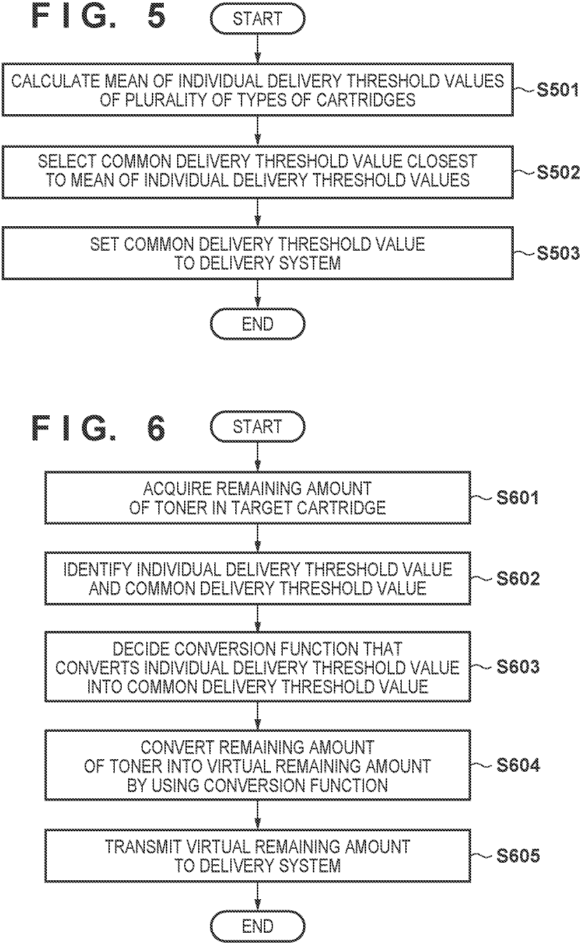

Next, referring to FIG. 5, a method for setting a common delivery threshold for cartridges that can be mounted on the image forming apparatus 100 will be described. The method may be implemented by executing, by a processor (e.g., CPU 311) of the device management system 400, a program read into the memory (e.g., RAM 313). The operation of FIG. 5 may be performed on a new image forming apparatus 100 in response to a fact that the new image forming apparatus 100 to be managed is added under the control of the device management system 400. In addition, the operation of FIG. 5 may be performed on an image forming apparatus 100 in response to a change in the configuration (e.g., type of cartridge usable, or individual delivery threshold) of the image forming apparatus 100 being managed by the device management system 400.

At S501, the device management system 400 calculates the mean of individual delivery thresholds of the corresponding plurality of types of cartridges that can be mounted on the image forming apparatus 100 to be set. The mean may be calculated as a simple mean or may be calculated as a weighted mean. For example, an individual delivery threshold is preliminarily set to each type of cartridge by the user and stored in the image forming apparatus 100.

At S502, the device management system 400 selects a value closest to the mean calculated at S501 among the common delivery thresholds that can be set to the delivery system 402. For example, assuming that the common delivery threshold can be set to the delivery system 402 in a range from 0% to 100% with an increment of 5%, and the mean of individual delivery thresholds is 20%. The foregoing case results in a common delivery threshold of 20%.

At S503, the device management system 400 sets the common delivery threshold selected at S502 to the delivery system 402. In the method illustrated in FIG. 5, the device management system 400 calculates a common delivery threshold and sets the common delivery threshold to the delivery system 402. Alternatively, a common delivery threshold may be set by the user or the administrator of the device management system 400 and may be set to the delivery system 402.

Next, referring to FIG. 6, details of S413 and S414 illustrated in FIG. 4 will be described. The steps may be performed by executing, by a processor (e.g., CPU 311) of the device management system 400, a program read into the memory (e.g., RAM 313). S601 to S603 in FIG. 6 correspond to S413 in FIGS. 4, and S604 in FIG. 6 corresponds to S414 in FIG. 4. The operation illustrated in FIG. 6 is performed on a cartridge subject to be processed mounted on the image forming apparatus 100 subject to be individually processed.

At S601, the device management system 400 acquires the remaining amount of toner in the cartridge being used in the image forming apparatus 100 subject to be processed. The remaining amount of toner is included in the toner information transmitted from the image forming apparatus 100.

At S602, the device management system 400 identifies the individual delivery threshold set to the cartridge subject to be processed, and the common delivery threshold set to the plurality of types of cartridges that can be mounted on the image forming apparatus 100 subject to be processed. The individual delivery threshold and the common delivery threshold may be set as described above and preliminarily stored in the device management system 400.

At S603, the device management system 400 decides a conversion function that converts the individual delivery threshold identified at S602 into the common delivery threshold identified at S602. For example, the device management system 400 may decide, as the conversion function, a function representing a curve passing through a control point represented by a pair of an individual delivery threshold and a common delivery threshold, and a control point commonly used for deciding the conversion function for a plurality of types of cartridges.

At S604, the device management system 400 converts the remaining amount acquired at S601 into a virtual remaining amount by using the conversion function decided at S603. More specifically, the device management system 400 defines the virtual remaining amount as an output that results from inputting the remaining amount acquired at S601 to the conversion function.

At S605, the device management system 400 transmits the virtual remaining amount acquired at S604 to the delivery system 402 as the remaining amount of the toner in the cartridge subject to be processed.

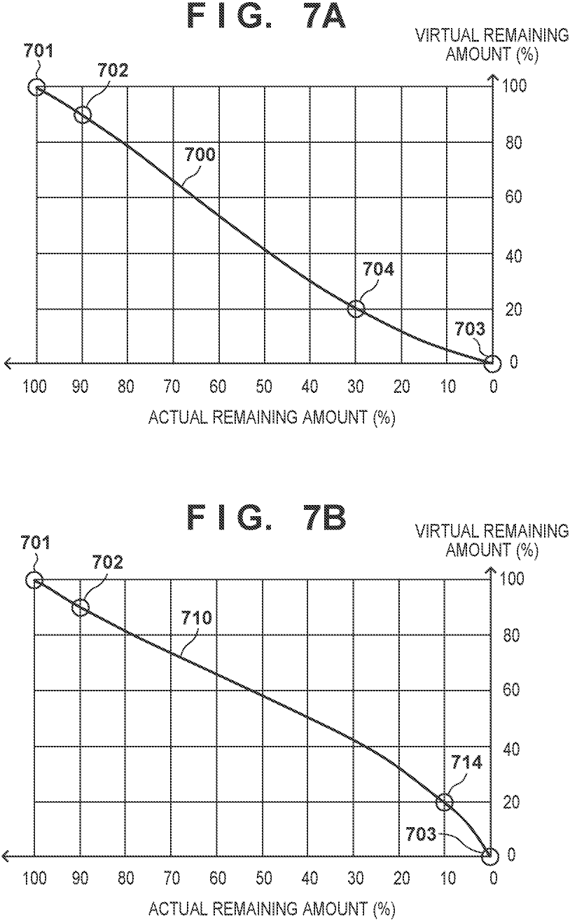

A specific example of a method for deciding a conversion function will be described, referring to FIGS. 7A and 7B. FIG. 7A illustrates a conversion function for a case where the cartridge subject to be processed is a standard cartridge. The foregoing is an example of a case where the individual delivery threshold that has been set to the cartridge subject to be processed is higher than the common delivery threshold. FIG. 7B illustrates a conversion function for a case where the cartridge subject to be processed is a large-capacity cartridge. The foregoing is an example of a case where the individual delivery threshold that has been set to the cartridge subject to be processed is lower than the common delivery threshold. In the following, assuming as with the aforementioned example that the individual delivery threshold for the standard cartridge is 30%, the individual delivery threshold for the large-capacity cartridge is 10%, and the common delivery threshold for the standard cartridge and the large-capacity cartridge is 20%.

In FIGS. 7A and 7B, the horizontal axes of the graphs indicate the remaining amount of toner acquired from the image forming apparatus 100, and the vertical axes of the graphs indicate the virtual remaining amount of toner to be transmitted to the delivery system 402. The remaining amount of toner acquired from the image forming apparatus 100 is referred to as actual remaining amount in the following description.

As illustrated in FIG. 7A, the device management system 400 decides a function representing a curve 700 passing through four control points 701 to 704 as the conversion function, when the cartridge subject to be processed is a standard cartridge. The curve 700 may be a cubic spline curve, or other types of curves. The control point 701 is a point at which an expression (actual remaining amount, virtual remaining amount) = (100%, 100%) holds. The control point 702 is a point at which an expression (actual remaining amount, virtual remaining amount) = (90%, 90%) holds. The control point 703 is a point at which an expression (actual remaining amount, virtual remaining amount) = (0%, 0%) holds. The control point 704 is a point at which an expression (actual remaining amount, virtual remaining amount) = (individual delivery threshold, common delivery threshold) holds, which is, in the aforementioned example, a point at which an expression (actual remaining amount, virtual remaining amount) = (30%, 20%) holds. The positions of the control points 701 to 703 may be preliminarily set and stored in the device management system 400 by the user or the administrator of the device management system 400. The position of the control point 704 is decided according to a preset individual delivery threshold and a common delivery threshold. When the cartridge subject to be processed is the standard cartridge, the device management system converts, at the aforementioned step S604, the remaining amount of toner into a virtual remaining amount by using the conversion function representing the curve 700.

As illustrated in FIG. 7B, the device management system 400 decides a function representing a curve 710 passing through four control points 701 to 703 and 710 as the conversion function, when the cartridge subject to be processed is a large-capacity cartridge. The curve 710 may be a cubic spline curve, or other types of curves. The curve 710 may be decided based on the same algorithm as that used for the curve 700. The control points 701 to 703 are the same points as those for the case where the cartridge subject to be processed is the standard cartridge. The control point 714 is a point at which an expression (actual remaining amount, virtual remaining amount) = (individual delivery threshold, common delivery threshold) holds, which is, in the aforementioned example, a point at which an expression (actual remaining amount, virtual remaining amount) = (10%, 20%) holds. The position of the control point 714 is decided according to a preset individual delivery threshold and a common delivery threshold. When the cartridge subject to be processed is the large-capacity cartridge, the device management system converts, at the aforementioned step S604, the remaining amount of toner into a virtual remaining amount by using the conversion function representing the curve 710.

As has been described above, because individual conversion functions are used for respective cases where the cartridge subject to be processed is a standard cartridge and a large-capacity cartridge, the individual delivery threshold is converted into the common delivery threshold regardless of the type of cartridge being used. Therefore, toner is delivered at an appropriate timing because the virtual remaining amount falls below a common delivery threshold when the actual remaining amount falls below the individual delivery threshold regardless of the type of cartridge subject to be processed.

The three control points 701 to 703 commonly used for deciding the curves 700 and 710 are set so that the conversion function representing the curve 700 or 710 generated including the individual control points 704 or 714 according to the type of cartridge increases strictly monotonically. Setting the control points in the aforementioned manner allows for acquiring a conversion function that causes the virtual remaining amount to continuously decrease in accordance with continuously decrease of the actual remaining amount. Transmitting the virtual remaining amount that continuously changes in the aforementioned manner to the delivery system 402 allows the delivery system 402 to grasp the decrease of toner in the image forming apparatus 100 over time.

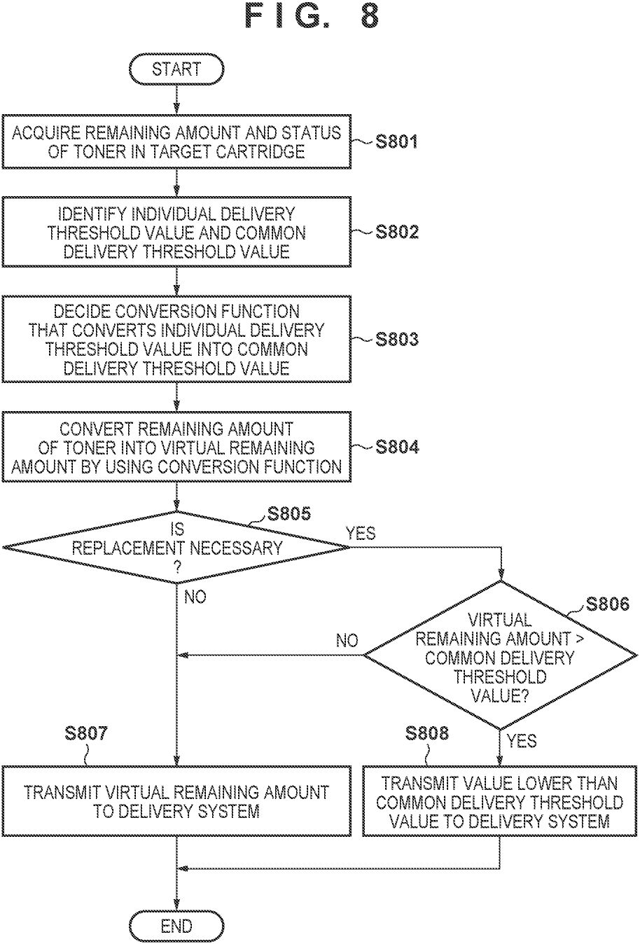

Referring to FIG. 8, a variation example of the aforementioned embodiment will be described. The variation example allows for notifying the delivery system 402 that the cartridge being used in the image forming apparatus 100 is to be replaced due to reasons other than shortage of the remaining amount of toner, by transmitting the remaining amount of toner to the delivery system 402.

FIG. 8 illustrates details of S413 and S414 in FIG. 4 in the case of variation example. The steps may be performed by executing, by a processor (e.g., CPU 311) of the device management system 400, a program read into the memory (e.g., RAM 313). S801 to S804 in FIG. 8 correspond to S413 in FIGS. 4, and S805 to S808 in FIG. 8 correspond to S414 in FIG. 4. The operation illustrated in FIG. 8 is performed on the cartridge subject to be processed mounted on the image forming apparatus 100 subject to be individually processed.

At S801, the device management system 400 acquires the remaining amount of toner and status of the toner in the cartridge being used in the image forming apparatus 100 subject to be processed. The remaining amount of toner is included in the toner information transmitted from the image forming apparatus 100. The status of toner includes status regarding whether the cartridge being used in the image forming apparatus 100 is to be replaced. S802 to S804 are equivalent to S602 to S604.

At S805, the device management system 400 determines whether the cartridge subject to be processed is to be replaced, based on the status of toner. Upon determining that the cartridge subject to be processed is to be replaced (“YES” at S805), the device management system 400 advances the process to S806, otherwise (“NO” at S805) advances the process to S807. S807 is equivalent to S605. Thus, upon determining that the cartridge subject to be processed is not to be replaced, the device management system 400 transmits the virtual remaining amount to the delivery system 402 as the remaining amount of toner of the image forming apparatus 100.

At S806, the device management system 400 determines whether the virtual remaining amount is greater than the common delivery threshold. Upon determining that the virtual remaining amount is greater than the common delivery threshold (“YES” at S806), the device management system 400 advances the process to S808, otherwise (“NO” at S806) advances the process to S807. Although the device management system 400 advances the process to S807 when the virtual remaining amount is equal to the common delivery threshold in this example, it may alternatively advance the process to S808.

At S808, the device management system 400 transmits a value lower than the common delivery threshold to the delivery system 402 as the remaining amount of toner of the image forming apparatus 100. Here, the value to be transmitted may be decided based on the common delivery threshold, such as a value acquired by subtracting for example an amount worth 1% from the common delivery threshold. As such, upon determining that the virtual remaining amount is greater than the common delivery threshold, the device management system 400 can cause the delivery system 402 to deliver the toner by transmitting a value lower than the common delivery threshold to the delivery system 402. On the other hand, upon determining that the virtual remaining amount is less than the common delivery threshold, the device management system 400 transmits the virtual remaining amount to the delivery system 402 at S807 as the remaining amount of toner of the image forming apparatus 100. Because the virtual remaining amount is less than the common delivery threshold, the delivery system 402 delivers the toner also in this case. Additionally, transmitting the virtual remaining amount calculated based on the actual remaining amount of the toner in this case allows the delivery system 402 to grasp the change of toner over time in the image forming apparatus 100.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-077694, filed May 10, 2022, which is hereby incorporated by reference herein in its entirety.

What is claimed is:

1. A device management system cooperating with a delivery system configured to deliver a recording material based on a comparison result between a remaining amount of the recording material to be used in a printing apparatus and a delivery threshold, the device management system comprising:
an acquisition unit configured to acquire a remaining amount of a recording material in the printing apparatus;
a conversion unit configured to convert the remaining amount of the recording material in the printing apparatus into a virtual remaining amount; and
a transmission unit configured to transmit the virtual remaining amount to the delivery system as the remaining amount of the recording material in the printing apparatus.

2. The device management system according to claim 1, wherein
the conversion unit converts the remaining amount of the recording material in the printing apparatus into the virtual remaining amount by using a conversion function, and
the conversion function converts a first delivery threshold individually set to an individual cartridge being used in the printing apparatus into a second delivery threshold commonly set to a plurality of types of cartridges usable in the printing apparatus.

3. The device management system according to claim 2, wherein the first delivery thresholds individually set to the plurality of types of cartridges are different from each other.

4. The device management system according to claim 2, further comprising a decision unit configured to decide, as the conversion function, a function representing a curve passing through a first control point and a second control point, the first control point represented by a pair of the first delivery threshold and the second delivery threshold, the second control point commonly used to decide the conversion function for the plurality of types of cartridges.

5. The device management system according to claim 2, further comprising a determination unit configured to determine whether a cartridge of the cartridges being used is to be replaced,
wherein, when the cartridge being used is determined to be replaced, the transmission unit transmits a value lower than the second delivery threshold to the delivery system as the remaining amount of the recording material in the printing apparatus.

6. The device management system according to claim 5, wherein, when the cartridge being used is determined to be replaced and the virtual remaining amount is determined to be less than the second delivery threshold, the transmission unit transmits the virtual remaining amount to the delivery system as the remaining amount of the recording material in the printing apparatus.

7. The device management system according to claim 5, wherein, when the cartridge being used is determined to be replaced and the virtual remaining amount is determined to be greater than the second delivery threshold, the transmission unit transmits a value lower than the second delivery threshold to the delivery system as the remaining amount of the recording material in the printing apparatus.

8. The device management system according to claim 5, wherein, when the cartridge being used is determined not to be replaced, the transmission unit transmits the virtual remaining amount to the delivery system as the remaining amount of the recording material in the printing apparatus.

9. A method for cooperating with a delivery system configured to deliver a recording material based on a comparison result between a remaining amount of the recording material to be used in a printing apparatus and a delivery threshold, the method comprising:
acquiring a remaining amount of a recording material in the printing apparatus;
converting the remaining amount of the recording material in the printing apparatus into a virtual remaining amount; and
transmitting the virtual remaining amount to the delivery system as the remaining amount of the recording material in the printing apparatus.
